(19) United States
(12) Patent Application Publication
(10) Pub. No.: US 2019/0347621 A1
(43) Pub. Date: Nov. 14, 2019

(54) PREDICTING TASK DURATIONS

(71) Applicant: Microsoft Technology Licensing, LLC, Redmond, WA (US)

(72) Inventor: Ryen William WHITE, Woodinville, WA (US)

(21) Appl. No.: 15/977,364

(22) Filed: May 11, 2018

(51) Int. Cl. G06Q 10/10; G06N 7/00

(52) U.S. Cl. CPC G06Q 10/1097; G06N 7/005

(57) ABSTRACT

Systems, methods, and apparatuses for resolving duration estimates for various tasks. A duration calculating system receives task information. The task information includes characteristics and metadata, which are derivable from the received task information. A duration for the task is estimated based on characteristics, the metadata, and relevant historical data. The duration estimate may then be presented to a user and feedback as to the accuracy of the estimate may be collected. The feedback may, in turn, be added to the historical data to improve subsequent time estimates while respecting and protecting user privacy.

### BACKGROUND

Time management and calendar applications, such as Microsoft's Outlook® email and calendar application, are useful time management tools. These applications enable their users to create, schedule, and manage tasks, including appointments and meetings, for example. Further, personal digital assistants, such as Microsoft's Cortana® intelligent personal digital assistant, are increasingly being used to deliver similar functionalities.

Conventional time management and calendar applications and functionalities require a user to specify a duration to block out in the calendar (i.e., a total amount of time to reserve for the appointment), when a calendar appointment is created. In addition, the user is required to specify a start time and/or a completion time (i.e., a deadline). These requirements are burdensome, lead to inaccurate time estimates, and detract from an overall user experience. For example, users' cognitive biases may represent obstacles to accurate time estimates, which can result in less than optimal time management.

Innovations disclosed herein relate to automating these duration predictions, as well as to machine learning to improve these automatic duration predictions.

### BRIEF SUMMARY

This Brief Summary is provided to introduce a selection of concepts in simplified form. It is intended to provide basic understandings of some aspects of the disclosed, innovative subject matter. Its sole purpose is to present some concepts in a simplified form as a prelude to the more detailed description that is presented later. The introduced concepts are further described below in the Description.

This Brief Summary is not an extensive overview of the disclosed, innovative subject matter. Also, it is neither intended to identify “key,” “necessary,” or “essential” features of the claimed subject matter, nor is it intended to limit the scope of the claimed subject matter.

Innovations described herein generally pertain to strategies for automatically predicting the duration of a task so as to, for example, relieve burdens on users of time management and calendar applications.

Innovations described herein also generally pertain to strategies for using population-scale appointment data with distributional information about time allocated by individuals for tasks to build computational models for task duration estimation.

Innovations described herein also generally pertain to training machine-learned algorithms using large-scale appointment data to estimate task durations so as to, for example, avoid users' biases, perceptions, erroneous recollections and provide more accurate task duration estimates.

Innovations described herein also generally pertain to strategies for predicting the duration of a task by functionality that exhibits “artificial intelligence” (e.g., a digital personal assistant provided by a “smart” device). Accurate predictions, especially in such functionality, promotes: increased utility, wider adoption; and/or continued use of and interaction with it.

According to an aspect of the present invention, there is provided a method, comprising: identifying one or more characteristics of a received task; identifying one or more items of metadata of the received task; resolving one or more predictions of a duration of the received task presenting at least one of the one or more resolved predictions; and receiving feedback concerning an accuracy of the presented at least one of the one or more predictions. The predictions may be based on at least one identified characteristic, at least one item of metadata; and/or historical data.

The method may also include: adding an entry to a user calendar, when feedback indicates an accuracy of the at least one of the one or more predictions at least matches a threshold; ranking a plurality of tasks comprising a list of tasks based on the one or more resolved predictions for the tasks; and providing, when the task is an appointment, the one or more predictions during appointment creation.

According to another aspect of the present invention, there is provided a trainable system, including: a task feature identifier portion that identifies one or more characteristics of a received task; a data store that stores historical data including task duration information concerning prior tasks; a duration predictor that calculates one or more duration predictions of the received task, based on the historical data and the one or more characteristics; a feedback obtainer that receives feedback concerning an accuracy of the one or more duration predictions; and an updater that adds the feedback to the historical data.

According to still another aspect of the present invention, there is provided a method, including: deducing context information of a received task; identifying relevant historical data related to the received task; calculating duration estimate based on extracted context information and identified relevant historical data; obtaining feedback about an accuracy of the duration estimate; and updating historical data with obtained feedback.

Furthermore, the present invention may be embodied as a computer system, as any individual component of such a computer system, as a process performed by such a computer system or any individual component of such a computer system, or as an article of manufacture including computer storage with computer program instructions and which, when processed by computers, configure those computers to provide such a computer system or any individual component of such a computer system. The computer system may be a distributed computer system. The present invention may also be embodied as software or processing instructions.

These, additional, and/or other aspects and/or advantages of the present invention are: set forth in the detailed description which follows; possibly inferable from the detailed description; and/or learnable by practice of the present invention. So, to the accomplishment of the foregoing and related ends, certain illustrative aspects of the claimed subject matter are described herein in connection with the following description and the annexed drawings. These aspects are indicative of various ways in which the subject matter may be practiced, all of which are within the scope of the claimed subject matter. Other advantages, applications, and novel features may become apparent from the following detailed description when considered in conjunction with the drawings.

### BRIEF DESCRIPTION OF THE DRAWINGS

The accompanying drawings, which are incorporated herein and form part of the specification, illustrate aspects of the present invention and, together with the description, further serve to explain principles of the present invention and to enable a person skilled in the relevant art(s) to make and use the invention. These aspects are consistent with at least one embodiment of the present invention.

FIG. 1A is a simplified block diagram illustrating an example of a distributed computing system that implements a digital personal assistant that tailors responsive outputs in a manner that is consistent with one or more embodiments of the present invention.

FIG. 1B is a block diagram illustrating an exemplary end user device with a remote personal digital assistant backend usable with the distributed computing system of FIG. 1A.

FIG. 2 is a block diagram of an exemplary digital personal assistant backend that may be implemented by the digital assistant of FIG. 1B.

FIG. 3 is a flowchart illustrating a method of predicting a task duration in a manner that is consistent with one or more embodiments of the present invention.

FIG. 4 is a flowchart illustrating a method of calculating one or more task duration estimates in a manner that is consistent with one or more embodiments of the present invention.

FIG. 5 is a flowchart illustrating calculating a duration to complete a task, illustrated by FIG. 4, in more detail.

FIG. 6 is a flowchart illustrating obtaining feedback about the accuracy of one or more duration predictions, illustrated by FIG. 5, in more detail.

FIG. 7 is a simplified block diagram illustrating an example of an end user device that is usable in the system of FIG. 1A to implement a digital personal assistant that automatically estimates task durations in a manner that is consistent with one or more embodiments of the present invention, in which the digital personal assistant is included within the user computing device.

FIG. 8 is a block diagram illustrating an example of a mobile computing device of FIG. 1A that may be used to implement a digital personal assistant that tailors responsive outputs in a manner that is consistent with one or more embodiments of the present invention.

FIG. 9 is a block diagram illustrating an example of a general computing device of FIG. 1A that may be used to implement a digital personal assistant that tailors responsive outputs in a manner that is consistent with one or more embodiments of the present invention.

FIGS. 10A and 10B illustrate examples of binned output related to duration predictions.

### DESCRIPTION

### I. Introduction and Lexicography

Preliminarily, some of the figures describe one or more concepts in the context of one or more structural components, variously referred to as functionality, modules, features, elements, etc. The various components shown in the figures can be implemented in any manner, for example, by software, hardware (e.g., discrete logic components), firmware, and so on, or any combination of these implementations. In one case, the illustrated separation of various components in the figures into distinct units may reflect the actual use of corresponding distinct components. Additionally, or alternatively, any single component illustrated in the figures may be implemented by plural components. Additionally, or alternatively, the depiction of any two or more separate components in the figures may reflect different functions performed by a single component.

Others of the figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented by software, hardware (e.g., discrete logic components), firmware, manual processing, etc., or any combination of these implementations.

The various aspects of the inventor's innovative discoveries are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of persons skilled in the relevant art(s) to implement such feature, structure, or characteristic in connection with other embodiments whether or not explicitly described.

As to terminology, the phrase “configured to” is both contemplated and to be understood to encompass any way that any kind of functionality can be constructed to perform an identified operation. The functionality can be configured to perform an operation using, for instance, software, hardware (e.g., discrete logic components), firmware etc., or any combination thereof.

The term “logic” is both contemplated and to be understood to encompass any functionality for performing a task. For instance, each operation illustrated in the flowcharts corresponds to logic for performing that operation. An operation can be performed using, for instance, software, hardware (e.g., discrete logic components, etc.), firmware, etc., or any combination thereof. So, references to logic include references components, engines, and devices.

The term “computing device” is both contemplated and to be understood to encompass any processor-based electronic device that is capable of executing processing instructions to provide specified functionality. Examples include desktop computers, laptop computers, tablet computers, server computers, multiprocessor systems, microprocessor-based systems, network PCs, minicomputers, and mainframe computers. Additional examples include programmable consumer electronics, appliances, especially so-called “smart” appliances such as televisions. Still other examples include devices that are wearable on the person of a user or carried by a user, such as cellphones, personal digital assistants (PDAs), smart watches, voice recorders, portable media players, handheld gaming consoles, navigation devices, physical activity trackers, and cameras. Yet another non-limiting example is a distributed computing environment that includes any of the above types of computers or devices, and/or the like.

The term “example” and the phrases “for example” and “such as” are to be understood to refer to non-limiting examples. Also, any example otherwise proffered in this detailed description are both intended and to be understood to be non-limiting.

The term “lookalike users” is both contemplated and to be understood to encompass users of the same or other technology who share one or more traits with a particular user. Lookalike users (and their associated data) are a way to leverage a smaller data set concerning a user to yield longer and/or wider baselines to reference. This is possible because lookalike users reflect or even share selected traits/characteristics with a reference set from a user. This makes extrapolations based on information corresponding to lookalike users pertinent. Also, the accuracy of inferences and deductions tends to increase with longer and/or wider baselines. Lookalike users (and their associated data) are identified via modelling.

The term “user experience” is both contemplated and to be understood to encompass the overall experience of a person using a product, such as a website, device, or computer application or software. It includes understanding what users need, what they value, their abilities, and also their limitations. This phrase is sometimes measured by, for example, ease of use, effectiveness, utility, and how pleasing it is to use.

The term “infer” is both contemplated and to be understood to encompass deducing or otherwise reaching a conclusion based on evidence and reasoning rather than based on explicit statements.

The term “task” is both contemplated and to be understood to encompass a variety of items of work to be done or undertaken that consume time, including item of a “to do” list, commitments made, requests received, and reminders.

The term “data” is both contemplated and to be understood to encompass both the singular and plural forms and uses.

The term “modulated data signal” is both contemplated and to be understood to encompass a signal that has one or more of its characteristics set or changed in such a manner as to encode information in the signal. By way of example, and not limitation, communication media includes wireless media such as acoustic, RF, infrared and other wireless media.

The term “communication media” is both contemplated and to be understood to encompass media that embody computer-readable instructions, data structures, program modules or other data in a modulated data signal such as a carrier wave.

The terms “computer program medium,” “storage media,” “computer-readable medium,” and “computer-readable storage medium,” as used herein, are both contemplated and to be understood to encompass memory devices or storage structures such as hard disks/hard disk drives, removable magnetic disks, removable optical disks, as well as other memory devices or storage structures such as flash memory cards, digital video disks, random access memories (RAMs), read only memories (ROM), and the like. Such computer-readable storage media are distinguished from and non-overlapping with communication media (do not include communication media).

The term “cloud” is both contemplated and to be understood to encompass a system that includes a collection of computing devices, which may be located centrally or distributed, that provide cloud-based services to various types of users and devices connected via a network, such as the Internet.

Conventional time management and calendar applications, including corresponding functionalities provided by digital assistants, provide a somewhat “blind” calendaring experience. This “blind” experience relies on a user to provide estimates/predictions for a task. Consequently, when users create calendar appointments they typically need to specify a duration of the appointment (i.e., a time block or blocks), as well as a start and/or finish time. This, in turn, requires that the users estimate how long a task may take to complete, every time an appointment is set. Additionally, the users are required to identify a start time or an end time. Accurate estimates and identifications are important to effective time management.

The requirements for a duration estimate for each calendar appointment can be burdensome, which results in a less than optimal user experience. Users may be unable to accurately estimate the amount of time that a task or task(s) will take them, for a variety of reasons. For example, a task might be new to the user. Additionally and/or alternatively, the task might be scheduled at an uncommon time, location, or with other participants. Still further, users often exhibit cognitive biases such as erroneous perceptions and recollections can affect the accuracy of task duration estimates. Inaccurate duration estimates, in turn, can lead to inaccurate and/or undesirable start and/or end times.

The inventor has discovered an innovative approach to providing duration estimates, which can relieve users of the burden of having to provide duration estimates. More specifically, the innovative approach automatically predicts a duration of a task (i.e., an estimate of length of time that a task will take to complete). One example of a task is an appointment, which is a way that people can set aside time to accomplish the task and is one way that the duration estimate can be used.

In this innovative approach, the automatic prediction may be based on, for example, information provided by the user, such as the appointment subject. Additionally and/or alternatively, the automatic prediction may be based on: metadata about the task (e.g., who the task is for, location, deadline, participants) and historical data (e.g., previous task durations for all tasks, previous task durations for similar tasks). This historical data may be from past user scheduling activity, scheduling activity of others, scheduling activity of lookalike users, and combinations thereof.

This innovative approach, in operation, enables a system, such as one providing a calendaring application and/or digital assistant functionalities, to make recommendations (e.g. by ranking duration options) or even just block time on the user's behalf. In a contemplated implementation, color and shading may be used to identify blocks of estimated durations awaiting a user's approval/modification/rejection.

Advantages of the inventor's innovative approach of automating the calculation of task duration estimates/predictions are many. For example, this automation avoids inaccuracies resulting from user cognitive biases, which tend to lead to inaccurate estimates/predictions. Also, this automation avoids inaccuracies arising from absence of experience estimating a duration for new a task (i.e., a task that a user has little or no experience accomplishing).

In detail, the inventor's innovative approach deduces/infers a context for a task (mined from the task description and metadata) and leverages both individual (i.e., personal) and macro (i.e., general population scale) calendaring data to resolve estimate(s) of the time(s) that may be required to complete the task.

Also, the innovative approach is trainable in that it uses feedback about the accuracy of duration estimates in subsequent estimates to improve future performance. In more detail, the inventor's approach adds accuracy feedback to historical data, which is usable for subsequent estimates and/or to train computational models used for subsequent estimates.

### II. Illustrative Distributed Computing System and Hardware

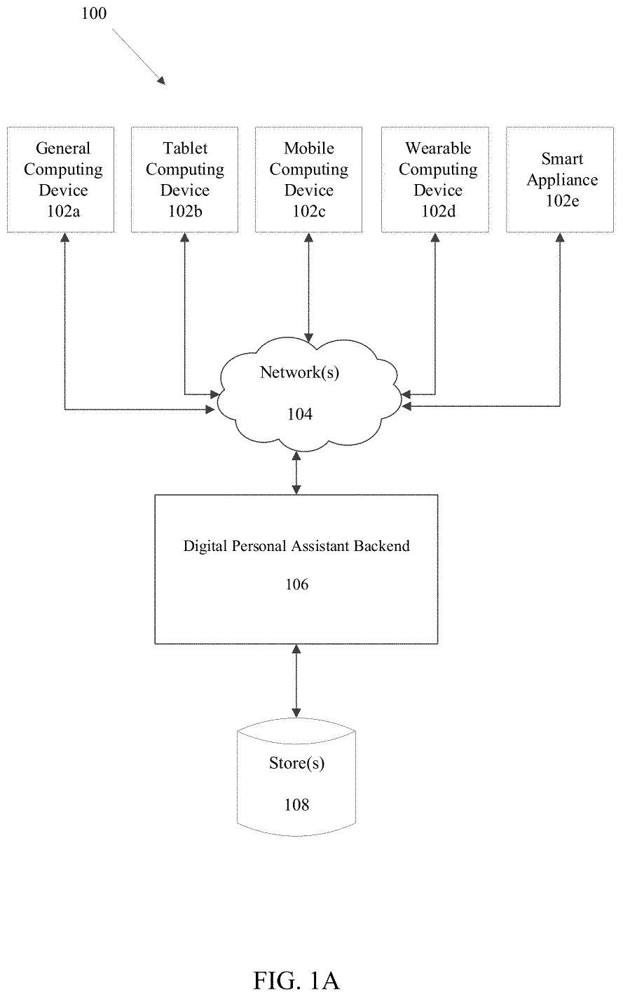

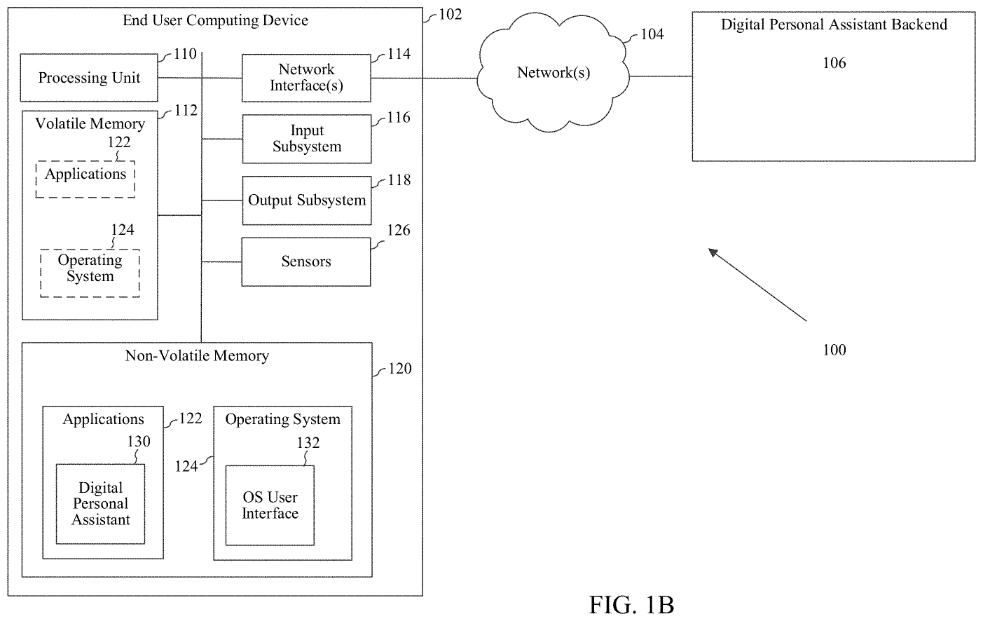

FIG. 1A is a block diagram of an example of a distributed computing system 100 that implements a digital personal assistant that predicts task duration(s) in a manner that is consistent with one or more embodiments of the present invention. FIG. 1B is a block diagram illustrating an exemplary end user device usable with the distributed computing system.

With concurrent reference to FIGS. 1A and 1B, the system 100 includes end user devices 102a-102e, which are each communicatively connected to a digital personal assistant backend 106 via network 104. The system also optionally includes one or more data stores 108.

Each illustrated end user device 102a-102e is a processor-based electronic device that is capable of executing a digital personal assistant 130 (shown in FIG. 1B) that is installed thereon. As FIG. 1A illustrates, the computing devices 102a-102e include, as illustrative examples, a general computing device 102a, a tablet computing device 102b, a mobile computing device 102c, a wearable computing device 102d, or a “smart” appliance 102e. It is to be understood, however, that the system 100 may include computing devices of a variety of other general purpose or special purpose computing hardware configurations, such as media devices.

The digital personal assistant 130 may be executed on behalf of a user of a respective one of the computing devices 102a-102e.

The network 104 interconnects the computing devices 102a-102e and the digital personal assistant back end 106. The network 104 permits an avenue of communication between the end user devices 102a-102e and the digital personal assistant backend 106. The network 104 may be any type of network or combination of networks suitable for facilitating communication between end user computing devices, such as end user devices 102a-102e and digital personal assistant backend 106. Examples of network 104 include a wide area network, a local area network, a circuit-switched network, and a wired network. The network 104 may also be a wireless network, such as a wireless fidelity (Wi-Fi) network, an Internet protocol (IP)-based network, and a cellular network. Further, the network 104 may be public or private.

The illustrated personal assistant backend 106 includes one or more servers that are programmed to provide services in support of the operations of digital personal assistant 130. The backend 106 may also be programmed to provide services in support of the operations of other digital personal assistants executing on other end user computing devices (not shown). For example, as will be discussed herein, personal assistant backend 106 is configured to provide services to digital personal assistant 130 relating to automatically estimating (i.e., predicting) a duration required for a user to complete a task and collect feedback concerning the accuracy of the estimations to improve the accuracy of subsequent predictions. In this way, the digital personal assistant backend 106 supports task scheduling in, for example, calendar applications or calendar functionalities via digital assistants.

Additionally or alternatively, the digital personal assistant backend 106 may comprise a cloud-based backend in which any one of a large number of suitably-configured machines may be arbitrarily selected to render one or more desired services in support of digital personal assistant 130. Such a cloud-based implementation provides a reliable and scalable framework for providing backend services to digital personal assistants, such as digital personal assistant 130.

It is to be understood that, in the implementation illustrated by FIG. 1A, the aforementioned services are respectively provided by the backend 106 and that the digital personal assistant backend may perform any number of other services on behalf of digital personal assistant 130, although such additional services may not be explicitly described herein. It is also to be understood that in alternative implementations, at least some of the aforementioned services are respectively provided by the computing device 102 on behalf of digital personal assistant 130, although such additional services may not be explicitly described herein.

In FIG. 1B, an end user device of the system of FIG. 1 is illustrated. The end user device may be, for example, device 102a of FIG. 1A.

As shown in FIG. 1B, the end user device 102 includes a plurality of interconnected components, including a processing unit 110, a volatile memory 112, one or more network interfaces 114, a user input subsystem 116, an output subsystem 118, and a non-volatile memory 120.

With continued concurrent reference to FIGS. 1A and 1B, the illustrated processing unit 110 includes one or more microprocessors, each of which may have one or more central processing units (CPUs) or microprocessor cores. The processing unit 110 executes computer programs (i.e., computer program logic). The execution of such computer programs causes the processing unit 110 to perform operations including digital personal assistant operations that will be described herein. Each of the non-volatile memory 120, the output subsystem 118, the user input subsystem 116, the network interface(s) 114, and the volatile memory 112 and may be connected to the processing unit 110 via one or more suitable interfaces.

The illustrated non-volatile memory 120 may include one or more computer-readable memory devices that operate to store computer programs and data in a persistent manner, such that stored information will not be lost even when the computing device 102 is without power or in a powered down state, for example. The non-volatile memory 120 may be implemented by, for example, read-only memory (ROM) devices, solid state drives, hard disk drives, magnetic storage media such as magnetic disks and associated drives, optical storage media such as optical disks and associated drives, and flash memory devices such as USB flash drives.

The illustrated volatile memory 112 includes one or more computer-readable memory devices that operate to store computer programs and data in a non-persistent manner, such that the stored information will be lost when end user device 102 is without power or in a powered down state, for example. Volatile memory 112 may be implemented by, for example, dynamic random access memory (DRAM) or other random access memory (RAM) devices.

The illustrated output subsystem 118 includes one or more devices through which responsive content, such as text and/or media, can be suitably delivered to the user so that the content may be consumed. The output subsystem 118 may be implemented by: a speaker, which is particularly useful to deliver responsive content with a sound element; a printer, which is particularly useful to deliver responsive content with a textual element; and a display, which is particularly useful to deliver responsive content with textual and/or visual element(s).

In the case of a display, for example, text and images can be rendered so that they will be visible to a user of end user device 102. Some or all of the rendering operations required to display such content may be performed at least in part by processing unit 110. Some or all of the rendering operations may also be performed by a display device interface such as a video or graphics chip or card (not shown in FIG. 1) that is coupled between processing unit 110 and the display. Depending upon the implementation of end user device 102, the display may comprise a device that is integrated within the same physical structure or housing as processing unit 110 or may comprise a monitor, projector, or other type of device that is physically separate from a structure or housing that includes processing unit 110 and connected thereto via a suitable wired and/or wireless connection.

The output subsystem 118 may also be a communications connection that allows the computing device 102 to deliver content to another device, such as a purpose-built device for specific content (e.g., a large television for visual content vs. a cellphone display), a communication medium. Some examples of communication media include wired media such as a wired network or direct-wired connection, and wireless media such as acoustic, RF, infrared and other wireless media. This implementation is particularly advantageous when the computing device 102 is a small appliance or wearable device.

The illustrated user input subsystem 116 includes one or more devices that operate to receive user inputs via a user's manipulation or control thereof. The input subsystem 116 may be implemented by, for example, a touch screen (e.g., a touch screen that may be integrated with a display of user subsystem 118), a keyboard, a keypad, a mouse, a touch pad, a trackball, a joystick, a pointing stick, a wired glove, a motion tracking sensor, a game controller or gamepad, or a video capture device such as a camera. Other devices are both possible and contemplated, however. Also, the input subsystem 116 may be selectively included/provided based on the expected use environment and types of responsive content to be delivered, for example. Further, depending on the implementation, each user input interface of the user input subsystem 116 may be integrated within the same physical structure or housing as processing unit 110 (such as an integrated touch screen, touch pad, or keyboard on a mobile device) or physically separate from a physical structure or housing that includes processing unit 110 and connected thereto via a suitable wired and/or wireless connection.

In some contemplated implementations, the user input comprises user speech that is captured by one or more microphones of the user input subsystem of the end user device 102. The responses generated by a digital personal assistant 130 may be made visible to the user in the form of text, images, or other visual content shown on a display of the output subsystem 118. The responses may also comprise computer-generated speech or other audio content that is played back via one or more speakers of the output subsystem 118. Functions of the personal digital assistant 130 will be described in more detail herein.

Also, it is both possible and contemplated that at least some of the input subsystem 116 can be implemented as a natural user interface (NUI), which is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface.

User input information may be received via cooperation of one or more of the input device(s) of the user input subsystem 116. The user input information is passed via a suitable interface to the processing unit 110 for processing.

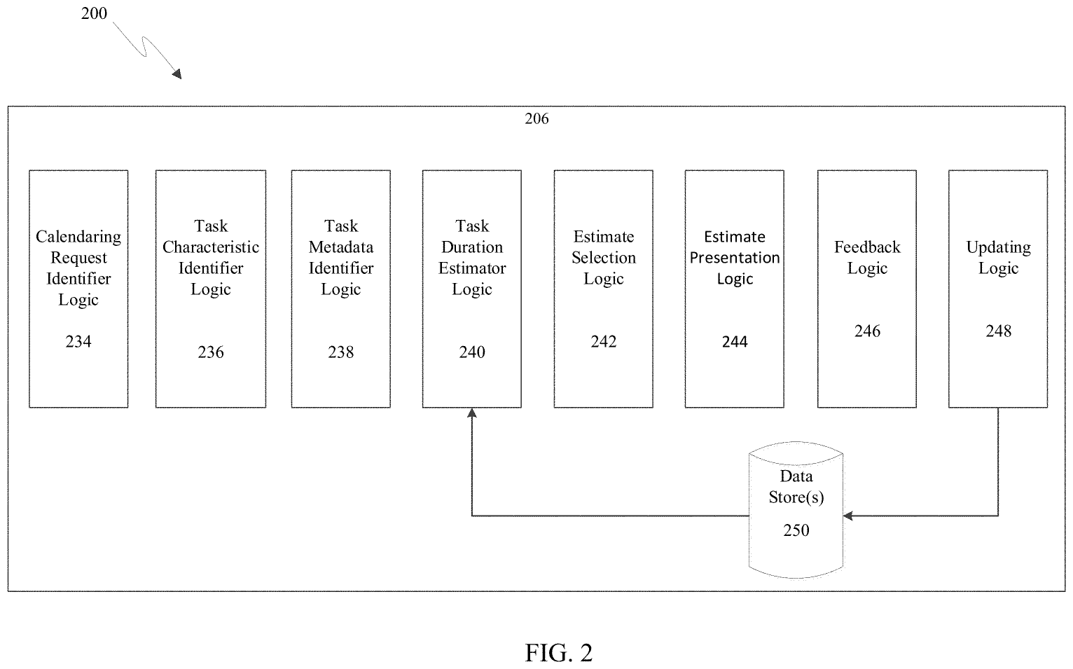

The sensor subsystem 126 may include one or more devices that detect or sense physical stimulus (such as motion, light, heat, sound, pressure, etc.) and generate a resulting signal (e.g., for measurement or control). Signals generated by the sensor subsystem 126 may be collected and processed by processing unit 110 or other logic within end user device 102 to support a variety of applications 122. In particular, the signals generated by the sensor subsystem 126 may be collected and processed by various logic shown in and explained with reference to FIG. 2 of the digital personal assistant backend 206 of FIG. 2. The functions of that logic are discussed below with reference to that FIG. 2.

It is both possible and contemplated that at least some of the device(s) of the user input subsystem 116 and at least some of the device(s) of the output subsystem 118 can be part of a housing that contains the various components of the computing device 102; can be separable from that housing and connected to the computing device 102 through various connection interfaces, such as a serial bus, wireless communication connection and the like; and can be separate from that housing and connected to the computing device 102 through various connection interfaces, such as a serial bus, wireless communication connection and the like.

Network interface(s) 114 may include one or more interfaces that enable the end user device 102 to communicate with, for example, the back end 106 over the network 104.

As further shown in FIG. 1B, non-volatile memory 120 stores a number of software components including one or more applications 122 and an operating system 124.

Each of the one or more applications 122 comprises a computer program or processing instructions that a user of end user device 102 may cause to be executed by processing unit 110. The execution of each application causes certain operations to be performed on behalf of the user, wherein the type of operations performed will vary depending upon how the application is programmed. Examples of the applications 122 may include, for example, a telephony application, a directory/reference application, an e-mail application, a messaging application, a Web browsing application, a calendar application, a utility application, a game application, a social networking application, a music application, a productivity application, a lifestyle application, a reference application, a travel application, a sports application, a navigation application, a healthcare and fitness application, a news application, a photography application, a finance application, a business application, an education application, a weather application, a books application, and/or a medical application.

As shown in FIG. 1B, applications 122 include the digital personal assistant 130, functions of which will be described in more detail herein.

Applications 122 may be distributed to and/or installed on end user device 102 in a variety of ways, depending upon the implementation. For example, in one contemplated implementation, at least one of the applications 122 may be downloaded from an application store and installed on end user device 102. In another contemplated implementation, in which end user device 102 is utilized as part of or in conjunction with an enterprise network, at least one of the applications 122 is distributed to end user device 102 by a system administrator using any of a variety of enterprise network management tools and then installed thereon. In yet another contemplated implementation, at least one of the applications 122 is installed on end user device 102 by a system builder, such as by an original equipment manufacturer (OEM) or embedded device manufacturer, using any of a variety of suitable system builder utilities. In still another contemplated implementation, an operating system manufacturer may include one or more of the applications 122 along with operating system 124 that is installed on end user device 102.

Operating system 124 comprises a set of instructions or even programs that manage resources and provide common services for applications that are executed on end user device 102, such as applications 122. Among other features, the operating system 124 may provide an operating system (OS) user interface 132. One example of the OS user interface 132 may include a component of operating system 124 that generates a user interface by which a user can interact with operating system 124 for various purposes, such as finding and launching applications, invoking certain operating system functionality, and setting certain operating system settings. In one contemplated implementation, the OS user interface 132 comprises a touch-screen based graphical user interface (GUI). In further accordance with such an example, one or more of the applications 122 installed on end user device 102 may be represented as an icon or tile within the GUI and invoked by a user through touch-screen interaction with the appropriate icon or tile. Here, the touchscreen would be included in the input subsystem 116. It is both possible and contemplated that the OS user interface 132 may reflect alternative user interface models.

Although applications 122 and operating system 124 are shown as being stored in non-volatile memory 120, it is to be understood that during operation of end user device 102, copies of applications 122, the operating system 124, or portions of either or both of the applications and the operating system, may be loaded to volatile memory 112 and executed therefrom as processes by processing unit 110.

In one contemplated implementation, the system 100 may receive various inputs and detect various information for a particular user from different ones of the end user devices 102a-102e. This scenario might commonly occur in a household environment where a particular user moves from room to room and interacts with the system 100 via various devices.

### III. Illustrative Task Duration Estimation System

As FIGS. 1A and 1B show, the computer program or processing instructions that provide the personal digital assistant 130 of this invention may be an application. It is to be understood, however, that the computer program or processing instructions that provide the personal digital assistant 130 may reside in the back end 106. This alternative configuration is illustrated in FIG. 2 and is discussed below with reference to that figure.

With continued reference to FIGS. 1A and 1B, the operating system 124 includes one or more sets of programs or processing instructions that manage resources and provide common services for applications 122 that are executed on the end user device 102, such as the applications 122. Although the applications 122 and the operating system 124 are shown as being stored in the non-volatile memory 120, it is to be understood that during operation of the end user device 102, the applications 122, the operating system 124, or portions thereof, may be loaded to the volatile memory 112 and executed therefrom by the processing unit 110.

The digital personal assistant 130 comprises a computer program or processing instructions that is/are configured to perform tasks, or services, for a user of the end user device 102 based on user input as well as features such as location awareness and the ability to access information (such as weather or traffic conditions, news, stock prices, user schedules, retail prices, etc.) from a variety of sources including online sources. Examples of tasks that may be performed by digital personal assistant 130 on behalf of the user include placing a phone call to a user-specified person, launching a user-specified application, sending a user-specified e-mail or text message to a user-specified recipient, playing user-specified music, scheduling a meeting or other event on a user calendar, obtaining directions to a user-specified location, obtaining a score associated with a user-specified sporting event, posting user-specified content to a social media web site or microblogging service, recording user-specified reminders or notes, obtaining a weather report, obtaining the current time, setting an alarm at a user-specified time, obtaining a stock price for a user-specified company, finding a nearby commercial establishment, performing an Internet search, or the like.

Generally, the digital personal assistant 130 is configured to provide user interfaces by which a user can interact with time management or calendar applications/functionalities to create, schedule and manage tasks, receive one or more automated time estimate(s) of how much time a task will take to complete, and to provide feedback as to the accuracy of the time estimate(s), which enhances the accuracy of subsequent time estimates. This feedback also promotes machine learning.

Referring to FIG. 2, there is illustrated a task duration estimating system 200 with a digital personal assistant backend 206 that may be implemented by digital personal assistant 130 of FIG. 1B, alone or in conjunction with other applications or services executing on or accessible to end user device 102 of FIG. 1B.

The digital assistant backend 206 includes calendaring request identifier logic 234, task characteristic identifier logic 236, task metadata identifier logic 238, task duration estimator logic 240, estimate selection logic 242, estimate presentation logic 244, feedback logic 246, and updating logic 248, and one or more data stores 250.

The backend 206 may comprise part of digital personal assistant 130 of FIG. 1B or an application or service that is accessible to digital personal assistant 130, such as one of the applications 122 of FIG. 1B.

The calendaring request identifier 234 is operable to provide services to a digital personal assistant (e.g., digital assistant 130 of FIG. 1B) relating to recognizing a user intent (e.g., a directive) to set an appointment for a task. Such tasks may be received in various forms including by speech, by keystroke, and/or by a visual cue. It is contemplated that many queries to the digital personal assistant 130, if not a majority, will be in the form of speech. Accordingly, this logic 234 is described herein in the context of speech recognition. It is to be understood, however, that other forms of input (i.e., queries or directives) are both possible and contemplated.

More specifically, many calendaring requests will likely be in the form of natural language. In this case, logic 234 performs speech recognition in which raw speech data may be provided to logic 234 for identification of recognized speech segments, which can be parsed and used to formulate an appointment or calendar entry responsive to the received input.

It is contemplated that this logic 234 may operate in various listening states. One contemplated state is an active listening state, for example, in which the logic may receive and analyze detected speech to determine corresponding actions to take on a computing device. Here, the received speech could be signals from a microphone (not shown) of the input subsystem 116 of FIG. 1B. It is also contemplated that logic 234 may, at times, operate in a restricted or passive listening state in which the system 200 waits for a signal from, for example input subsystem 116, which is then used as a trigger to wake up and enter an active listening state. Still further, it is contemplated that the various listening states may correspond to different contexts of use.

It is contemplated that this logic 234 may perform various operations in the process of speech receipt and recognition. For example, it is both possible and contemplated that the calendaring request identifier logic 234 may: perform normalization and/or feature extraction functions on received digitized speech signals to obtain intermediate speech recognition results; perform filtering that may, for example, enhance the fidelity and understanding of the received audible query; and or perform additional speech processing, (e.g., natural language analysis, intent determination, and/or disambiguation of ambiguous speech inputs). In another contemplated implementation, the logic 234 may communicate with an external speech recognition service (not shown) to assist with the speech recognition process.

Logic 234 operates to receive the audio stream transmitted thereto by digital personal assistant 130 and to analyze the audio stream to determine the phonetic content thereof. Once logic 234 has determined the phonetic content of the audio stream, a determination of the presence or absence of a calendaring request is made. When a calendaring request is determined to be present, the request is passed on to task characteristic identifier logic 240.

Here, it is to be appreciated that it is both contemplated and possible that calendaring requests may be input in other ways. For example, a user input such a request via a conventional keyboard and mouse. Also, user input may be received via an image, the text of which having undergone a character recognition operation. Still further, the task may be user-generated from, for example, an item from a user's so-called “to-do” list.

Task characteristic identifier logic 236 is operable to provide services to a digital personal assistant (e.g., digital assistant 130 of FIG. 1B) relating to identification of characteristics of a task that may affect the time required to complete the task. Stated differently, logic 236 determines features/aspects of the task that could affect the time required to complete it. As can be appreciated, some aspects of a task can play more important roles when estimating a duration.

For example, logic 236 may identify one or more characteristics of a task based on an express description provided by a user when adding a task/appointment to a calendar. For example, a user's utterance “please block time for a meeting” would be an express description of a meeting task. Additionally and/or alternatively, logic 236 may consider specific, express descriptions of a task such as “take 5 minutes to call Mr. Smith” to determine the amount of time for the task and/or used as training data for the duration prediction logic 240, described below.

Metadata identifier logic 238 is operable to provide services to a digital personal assistant (e.g., digital assistant 130 of FIG. 1B) relating to identifying metadata relating to the task, including metadata that may affect the time required to complete the task. For example, logic 238 may identify one or more items of metadata of a task based on, for example, a type of the task, a location of the task, participants in the task, a deadline to complete the task.

The logic 236 and 238 may be operable, in synergistic combination, to deduce a context of a task to be added to a calendar. Further, as will be described below, in manners consistent with the present invention, this contextual information is combinable with macro scale historical information to calculate duration predictions for the task.

It is to be appreciated that in one or more contemplated embodiments, the extraction and use of task metadata may be optional. For example, when characteristics/features of task are extracted from a so-called “to-do” list, it would be possible to calculate one or more task duration estimates from the extracted characteristics/features alone. Thus, in such contemplated implementation(s), logic 238 may be omitted.

Duration estimator logic 240 is operable to provide services to a digital personal assistant (e.g., digital assistant 130 of FIG. 1B) relating to calculating one or more duration estimates of time that it may take to complete the task. It is contemplated that these duration predictions will be based on the identified task characteristics (from logic 236), task metadata (from logic 238), and historical data (from data store(s) 250).

Generally, the historical information may include previous task durations for all tasks and previous task durations similar tasks. Also, this data may be stored for a current user, so-called lookalike users of the same or different devices/applications, and other users. In at least one contemplated implementation, the historical data may be characterized as macro (i.e., population) -scale appointment data.

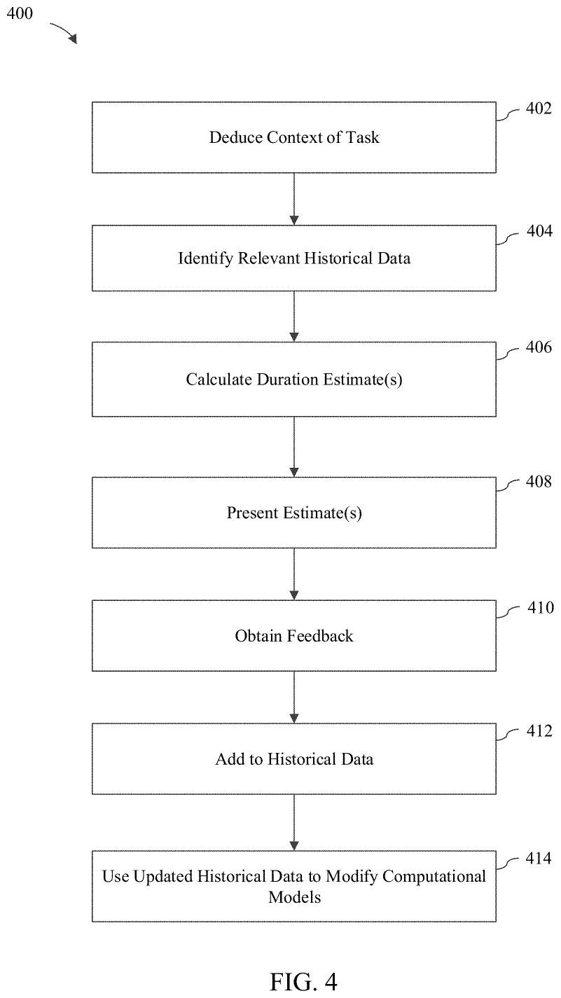

It is to be appreciated that this historical data is usable to build and/or train computational models for task duration estimation. The features, uses, and examples of this historical duration information are explained in detail below with reference to FIG. 4.

Estimate selection logic 242 is operable to provide services to a digital personal assistant (e.g., digital assistant 130 of FIG. 1B) relating to selecting at least one of the duration predictions calculated by logic 240. This selection may be realized via any number of approaches, including comparing scoring duration estimates and/or comparing them to a threshold. It is to be appreciated that logic 242 is optional. In a contemplated implementation, only a highest scored/most confident estimate may be presented.

The output of logic 242 may be in the form of a specific duration, or one of a set of time “bins” (e.g. <15 minutes, 30 minutes, 1 hour, >1 hour).

Presentation logic 244 is operable to provide services to a digital personal assistant (e.g., digital assistant 130 of FIG. 1B) relating to presenting at least one duration prediction to, for example, a user.

It is contemplated that many estimates from the digital personal assistant 130, if not a majority, will be in the form of speech. Accordingly, this logic 244 is described herein in the context of speech generation. It is to be understood, however, that other forms of output are both possible and contemplated.

More specifically, logic 244 performs speech generation and deliver an audible output in the form of speech via output subsystem 118 of FIG. 1B.

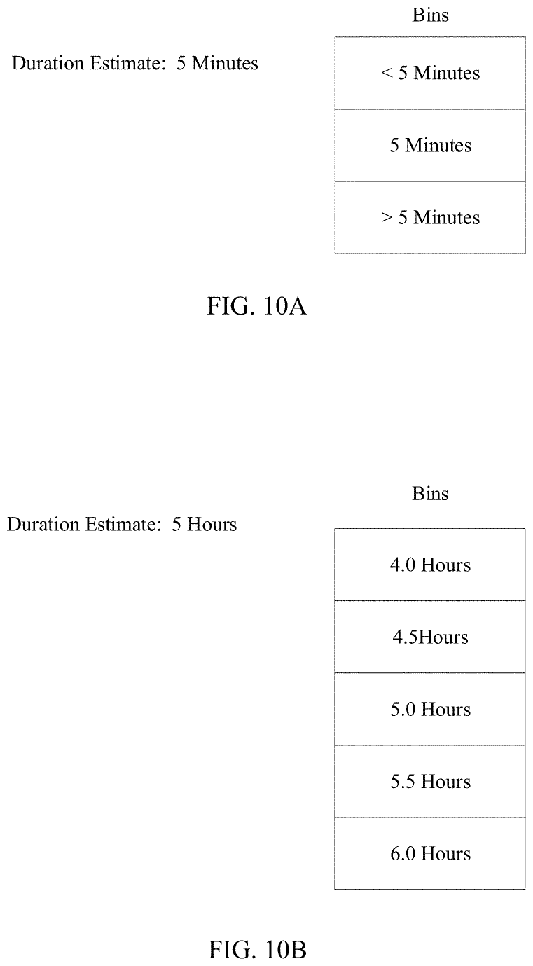

Referring now to FIGS. 10A and 10B, there are illustrated examples of the presentation of binned output of logic 242. The output can be one of a set of time bins (e.g. <15 minutes, 30 minutes, 1 hour, >1 hour). Here, it is to be appreciated that the number and/or size of these bins may be based on the estimated duration(s). So, for example, duration predictions of less than 60 minutes would not be presented with bins on the order of ¼ hour increments. Additionally and/or alternatively, the bins may be selected in advance by a user.

In one implementation, the bins are read to a user in order, for user selection. In another contemplated implementation, the bins can be offered to a user via a dropdown window pane. Additionally and/or alternatively, an “other” option may be provided for a user to override the offered bins.

Feedback logic 246 is operable to provide services to a digital personal assistant (e.g., digital assistant 130 of FIG. 1B) relating to collecting feedback concerning the accuracy of the presented duration prediction(s). This feedback may be from, for example, a user. Also, it is to be appreciated that the duration feedback recommendations may be: implicit, (e.g., user corrections to presented estimates or selections); or explicit (e.g., ratings or stars).

Furthermore, it is contemplated that this logic 246 may make deductions based at least in part, on user interaction with a calendaring application or personal data assistant. For example, if a user asks to move appointments after a specified appointment for which a duration estimate was made, logic 246 could infer that the estimate was not entirely accurate (i.e., too short).

Also, by reviewing user's past calendaring choices, patterns showing duration prediction estimates may advantageously be deduced without direct user participation. Also, by tracking user choices, more accurate duration predictions can be gathered on their behalf. This tracking may include analysis of previous calendar appointments for tasks that resemble the current task or otherwise.

Updating logic 248 is operable to provide services to a digital personal assistant (e.g., digital assistant 130 of FIG. 1B) relating to updating the historical data stored in the one or more data stores 250. In a contemplated implementation, logic 248 receives feedback about the accuracy of presented predicted duration(s) and adds the feedback to the historical data stored in the one or more data stores 250. In this way, the received feedback can be used to improve subsequent duration predictions made using the historical data. This updating is discussed in more detail below with reference to FIG. 4.

In some contemplated implementations, the feedback logic 248 is combined with the feedback logic 246 so that the functionality of the updating logic is achieved via the feedback logic alone.

### IV. Illustrative Method of Estimating a Task Duration

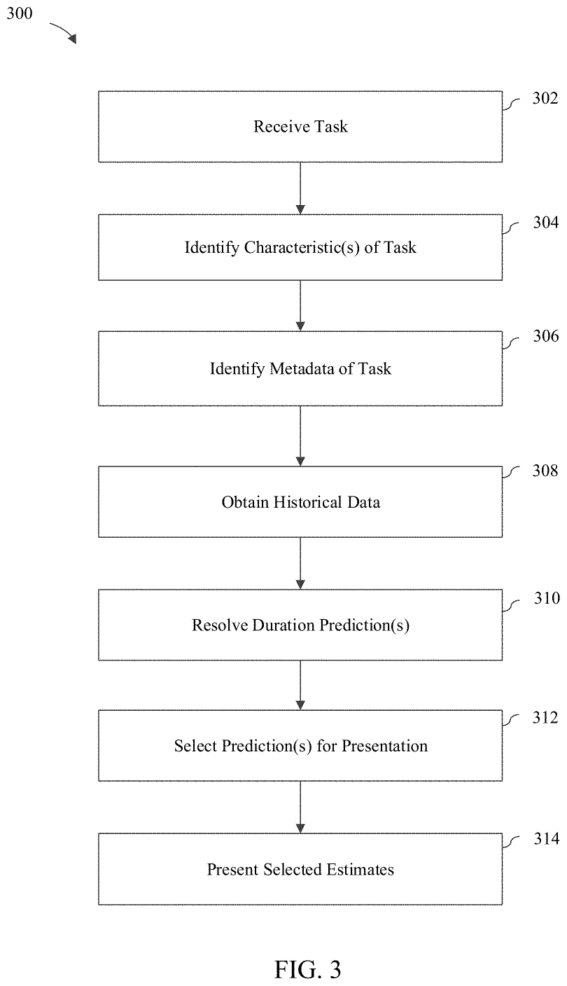

To help further illustrate functionality of system 200 of FIG. 2, as well as the foregoing techniques, additional reference is now made to FIG. 3. FIG. 3 illustrates a flowchart depicting a method 300 of automatically predicting a duration estimate for a calendaring task, in a manner that is consistent with one or more embodiments of the present invention. By the method 300, one or more duration predictions from which to choose may be presented to a user.

Method 300 may be executed as part of digital personal assistant functionality, such as digital personal assistant 130 of FIG. 1B and will be described below with continued reference to components of systems 100 and 200 of FIGS. 1A-2. Solely for efficiency and clarity, the method 300 will be described below with continued reference to various components and/or arrangements of the systems 100 of FIGS. 1A and 1B, along with those of system 200 of FIG. 2. It is both possible and contemplated that method 300 may be achieved by systems of other configurations and/or components, however.

At reference numeral 302, a task to be added to a calendar is received. As explained above, the task may be received via a textual input from a keyboard, an audio/sound input from a microphone, and/or extracted from a data file (e.g., a Word® document, an audio file, an email, a spreadsheet, an image file). It is also contemplated that this request may also be received from another device and/or inferred from a request to find time to accommodate a task, for example.

In a contemplated implementation, calendaring request identifier logic 234 of FIG. 2 may perform this operation.

At reference numeral 304, one or more characteristics of the received task are identified, including aspects that affect the time it would take to complete the task. Examples of these characteristics include, for example, a type of task (e.g., a meeting or an errand). Another example is a commitment to spend a specified amount of time on a task, such as a calendaring directive to block out time to watch a 30-minute sitcom on television. In still another example, a user may utter a calendaring directive such as “Cortana, please block time for a call to my mother” to a personal digital assistant. Also, for example, aspects of an email such as, for example, a sent date, a due date, an email subject (including whether the email is a reply), may be identified.

In a contemplated implementation, characteristic identifier logic 236 of FIG. 2 may perform this operation.

At reference numeral 306, one or more items of metadata about the task are identified. Examples of this metadata include, for example, the recipient of the output of the task and their relationship to the user, a time of the task, and how many participants will be involved in the tasks.

In a contemplated implementation, metadata identifier logic 238 of FIG. 2 may perform this operation.

Here, it is to be appreciated that in synergistic combination, the characteristics and metadata respectfully identified in operations 304 and 306 may comprise a context of the received task. This context is usable to select relevant historical data and/or one or more computational models, both usable to calculate task duration estimates.

It is to be appreciated that in one or more contemplated embodiments, the extraction and use of task metadata may be optional. For example, when characteristics/features of a task are extracted from a so-called “to-do” list, it would be possible to calculate one or more task duration estimates from the extracted characteristics/features alone. Thus, in such contemplated implementation(s), operation 306 may be omitted.

At reference numeral 308, historical data relevant to the received task is obtained. This historical data lengthens a baseline if information from which the duration estimate may be computed. Generally, this historical data is population scale (i.e., macro) calendaring data. This information may include user information, lookalike users' information, and information from a general population, either for tasks that resemble the received task or for tasks that do not.

So, the historical data may include information about: prior duration estimates for the task involving a user; prior duration estimates for the task involving users other than a user; prior duration estimates for tasks similar to the task involving the user; prior duration estimates for tasks similar to the task involving users other than the user; prior duration estimates for tasks dissimilar to the task involving the user; prior duration estimates for tasks dissimilar to the task involving users other than the user; and rules-based duration estimates (e.g., a call to directory assistance takes 90 seconds).

In a contemplated implementation, duration estimator logic 240 of FIG. 2 may perform this operation. Additionally and/or alternatively, other logic may perform this operation, in whole or in part.

At reference numeral 310 a duration estimate is predicted (i.e., calculated). As explained above, these calculations are based on identified characteristics of the received task, any identified metadata of the received task, and the selected historic data. Also, as discussed above, the estimating task duration(s) may be in the form of an exact time (e.g., 15 minutes) or in the formed of a binned representation (<15 mins, 30 mins, etc.).

In a contemplated implementation, duration estimator logic 240 of FIG. 2 may perform this operation.

At reference numeral 312 one or more of the calculated estimates for presentation are selected. It is to be appreciated that this operation is optional. In a contemplated implementation, all of the estimates may be presented, for example.

In a contemplated implementation, estimate selection logic 244 of FIG. 2 may perform this operation.

At reference numeral 314 estimates are presented. Here, a user may accept an estimate, modify the estimate, or reject the estimate.

Operation 314 may take various forms, in various contemplated implementations of the present invention. In one contemplated implantation, an entry to a user calendar is added when an accuracy of the at least one of the one or more predictions at least matches a threshold. In another contemplated implementation, an order of a plurality of tasks of a list is modified based on the one or more resolved predictions. In still another contemplated implementation, when the task is an appointment, the one or more predictions are presented during creation of the appointment in a calendar, for example.

In a contemplated implementation, estimate presentation logic 244 of FIG. 2 may perform this operation.

### V. Illustrative Method of Training a Model Usable by a Task Duration Estimator

The foregoing techniques may be further understood with reference to flowchart of method 400 of FIG. 4. In particular, FIG. 4 illustrates a method 400 by which a duration prediction model may be trained/updated to yield more accurate duration estimates for tasks.

The method of flowchart 400 will now be described with continued reference to system 200 as described above in reference to FIG. 2, although it is to be understood that the method is not limited to that system.

At reference numeral 402, a context of a task to be added to a calendar is deduced. This operation may include identifying characteristics/features of the task, as well as metadata about the task. This operation may be performed by logic 236 and 238 of the system of FIG. 2, in one contemplated implementation.

At reference numeral 404, historical data relevant to a duration to complete the task is identified from among a store of macro (i.e., population) -scale appointment data. It is to be appreciated that some item(s) of this information may be more relevant to the duration of given task data than other. Indeed, the historical data includes data from various populations, including similar and dissimilar users, as well as those who have performed similar and dissimilar tasks.

Also, it is to be appreciated that population-scale appointment data contains distributional information about times allocated by users for tasks. Further, this distributional information represents a virtual baseline from which more accurate duration estimates may calculated.

Further, it is to be appreciated that this distributional information can be useful to build computational models for task duration estimation. Additionally, machine-learned algorithms are trainable using large-scale appointment data to estimate task durations. These aspects are discussed below.

At reference numeral 406, a duration to complete the task is calculated (i.e., predicted). Here, one or more computational models may be used to operate of the deduced context and selected historical data. This operation, in a contemplated implementation, is similar to operation 310 of FIG. 3. Further, in a particularly advantageous implementation, machine learning and/or a trainable algorithm may be employed to provide this operability, in whole or in part.

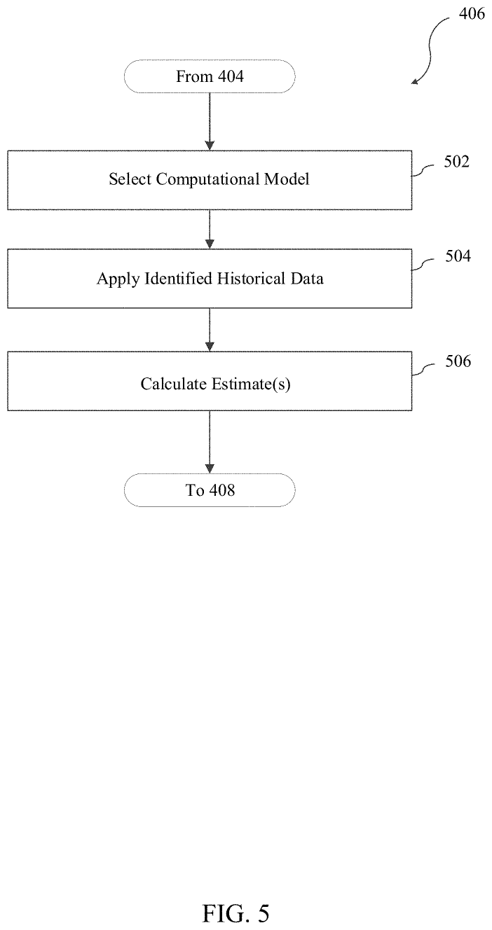

Referring now to FIG. 5, operation 406 is illustrated in more detail.

At reference numeral 502, a computational model is selected from a library of models. Here, the selection may be based on the deduced context, the selected historical data, or both. In a contemplated implementation, this model may include a trainable algorithm and/or be a neural network.

At reference numeral 504, the model selected in operation 502 is applied to the identified historical data and the deduced context information (e.g., task features and metadata).

At reference numeral 506, duration estimates are calculated.

Operation 406 may be performed by logic 240 of the system of FIG. 2, for example.

Referring again to FIG. 4, at reference numeral 408, one or more time duration predictions are presented to a user. This operation, in a contemplated implementation is similar to operation 312 of FIG. 3. Also, operation 408 may be performed by logic 242 of the system of FIG. 2, for example.

At reference numeral 410, feedback about the accuracy of one or more of the duration predictions is obtained. This feedback may be active. For example, a user's selection of a duration prediction is considered an endorsement of that prediction, evidencing the accuracy of it. Also, the feedback may be passive. For example, accuracy or inaccuracy may be inferred by whether a user extends a time block during the task.

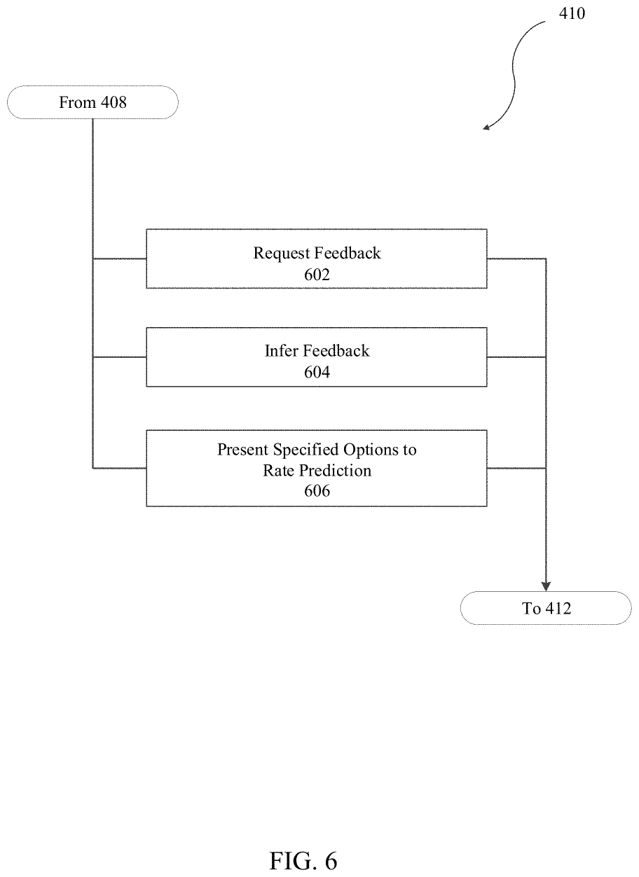

In more detail, reference is now made to FIG. 6, operation 410 is illustrated in more detail.

At reference numeral 602, feedback may be explicitly requested. For example, a user may be presented with a question such as “was this estimate accurate?” This question may be presented via text on a display or via sound from a speaker.

At reference numeral 604, feedback may be inferred. For example, the accuracy of a duration prediction may be inferred based on whether a user accepts and/or reuses a prediction for a similar task.

At reference numeral 606, feedback may be passively requested by, for example, offering a user an opportunity to rate a duration estimate.

Also, in a contemplated implementation, feedback logic 246 of FIG. 2 may perform operation 410, for example.

Referring again to FIG. 4, at reference numeral 412, the feedback about the accuracy of duration prediction(s), received in operation 410, is added to the historical data.

In detail, population-scale appointment data (i.e., historical data) contains distributional information about time allocated by individuals for tasks. Further, this distributional information may be useful to build computational models for task duration estimation and to train machine-learned algorithms. These models and algorithms, in turn, may advantageously guide design of calendaring support to help personal digital assistants find time for task completion and help users block the time required for a task. Thus, adding feedback about task duration estimates is advantageous because those additions serve to increase the distributional information, which improves subsequent estimates.

Here, it is to be appreciated that deep learning architectures, such as neural networks and the like, are particularly well-suited to identifying patterns in data sets. Consequently, expanding the historical data (and its distribution) helps deep learning architectures learn. This represents training of such architectures.

In a contemplated implementation, updating logic 248 of FIG. 2 may perform operation 412, for example. Further, this logic 248 may participate in the machine learning/model building discussed above.

### VI. Illustrative Alternative Example of End User Device

In system 100 of FIG. 1B, the digital personal assistant backend is located remotely with respect to user computing device 102. This, of course, is just one arrangement contemplated by the inventor.

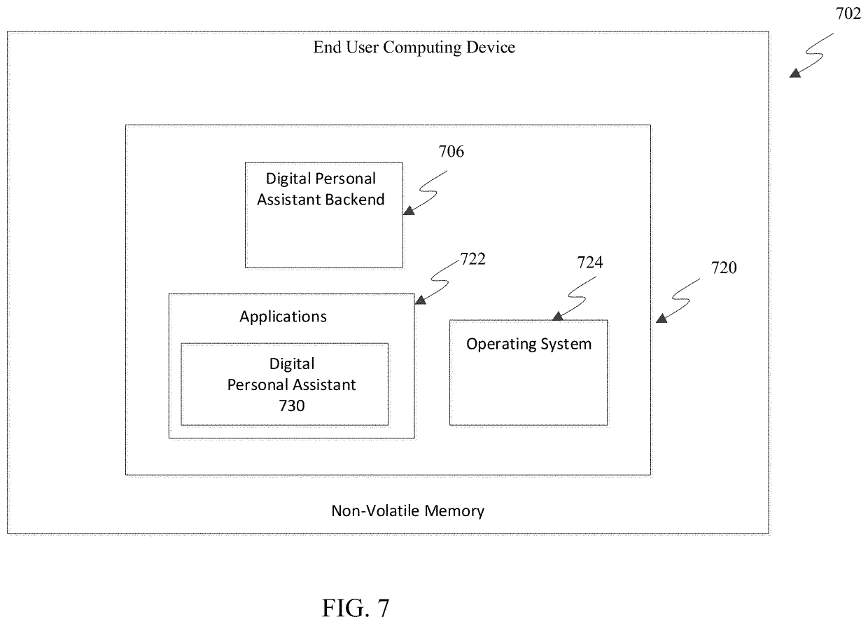

FIG. 7 is a block diagram of an alternative implementation in which the digital personal assistant backend 706 is actually included within an end user device 702. In particular, as shown in FIG. 7, end user device 702 includes a digital personal assistant 730 that is analogous to digital personal assistant 130 of system 100 of FIG. 1 and that performs similar functions. The digital personal assistant 730 is located in the non-volatile memory 720, along with the operating system 724 and the digital personal assistant backend 706.

In the configuration of FIG. 7, the end user device 702 does not require an avenue of communication between it and the digital personal assistant backend 706. Accordingly, the inclusion or presence of a network, such as network 104 of FIG. 1A is optional. Inclusion of a network permits the digital personal assistant 730 to access and retrieve remotely stored information from, for example, one or more data stores (not shown). Such data stores may store, for example, aggregated calendaring/appointment information for the same/similar tasks by a user, by lookalike users, or even calendaring/appointment information for dissimilar tasks.

It is to be understood that the arrangement of FIG. 7 is but one alternative example. Various other locations of the digital personal assistant backend, including distributed arrangements, are both possible and contemplated. For example, the digital personal assistant may be executed remotely with respect to the user computing device.

### VII. Illustrative Alternative Example of a Mobile End User Device

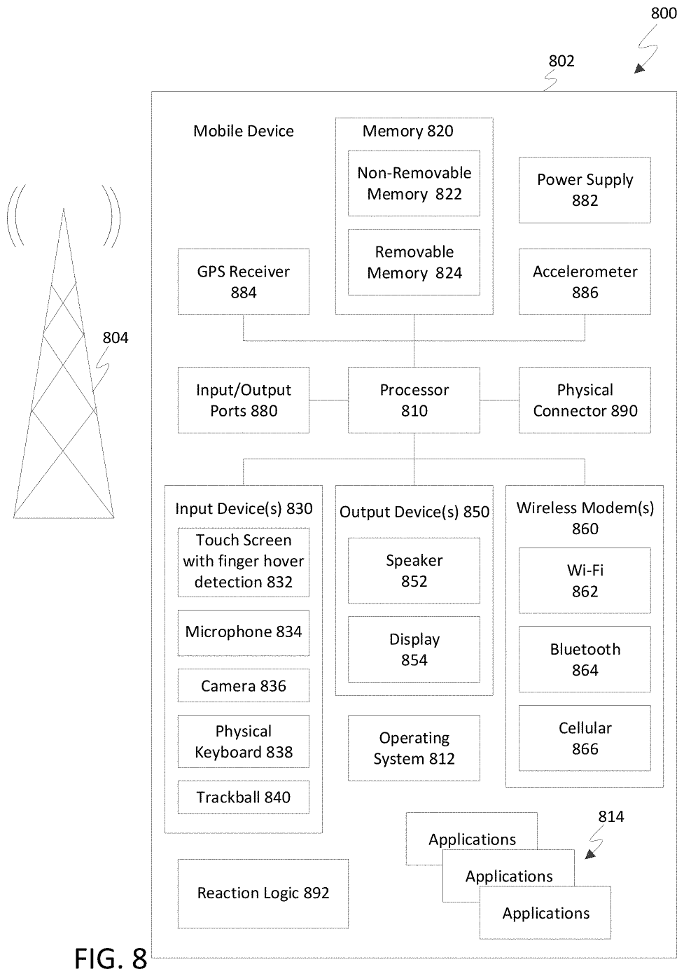

FIG. 8 is a block diagram of an exemplary mobile device 802 that may be used to implement end user device 102c of FIG. 1. As shown in FIG. 8, mobile device 802 includes a variety of optional hardware and software components. Any component in mobile device 802 can communicate with any other component, although not all connections are shown for ease of illustration. Mobile device 802 can be any of a variety of computing devices (e.g., cell phone, smartphone, handheld computer, Personal Digital Assistant (PDA), etc.) and can allow wireless two-way communications with one or more mobile communications networks 804, such as a cellular or satellite network, or with a local area or wide area network. The description of mobile device 802 provided herein is provided for purposes of illustration, and is not intended to be limiting. It is to be understood that one or more embodiments of the present invention may be implemented in other types of mobile devices or mobile devices of other configurations.

The illustrated mobile device 802 can include a controller or processor 810 (e.g., signal processor, microprocessor, ASIC, or other control and processing logic circuitry) for performing such tasks as signal coding, data processing, input/output processing, power control, and/or other functions. An operating system 812 can control the allocation and usage of the components of mobile device 802 and support for one or more application programs 814 (also referred to as “applications” or “apps”). Application programs 814 may include common mobile computing applications (e.g., e-mail applications, calendars, contact managers, Web browsers, messaging applications) and any other computing applications (e.g., word processing applications, mapping applications, media player applications). In one or more embodiments, application programs 814 include digital personal assistant 130.

The illustrated mobile device 802 can include memory 820. Memory 820 can include non-removable memory 822 and/or removable memory 824. Non-removable memory 822 can include RAM, ROM, flash memory, a hard disk, or other well-known memory devices or technologies. Removable memory 824 can include flash memory or a Subscriber Identity Module (SIM) card, which is well known in GSM communication systems, or other well-known memory devices or technologies, such as “smart cards.” Memory 820 can be used for storing data and/or code for running operating system 812 and applications 814. Example data can include Web pages, text, images, sound files, video data, or other data to be sent to and/or received from one or more network servers or other devices via one or more wired or wireless networks. Memory 820 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

Mobile device 802 can support one or more input devices 830, such as a touch screen 832, a microphone 834, a camera 836, a physical keyboard 838 and/or a trackball 840 and one or more output devices 850, such as a speaker 852 and a display 854. Touch screens, such as touch screen 832, can detect input in different ways. For example, capacitive touch screens detect touch input when an object (e.g., a fingertip) distorts or interrupts an electrical current running across the surface. As another example, touch screens can use optical sensors to detect touch input when beams from the optical sensors are interrupted. Physical contact with the surface of the screen is not necessary for input to be detected by some touch screens.

Other possible output devices (not shown) can include piezoelectric or other haptic output devices. Some devices can serve more than one input/output function. For example, touch screen 832 and display 854 can be combined in a single input/output device. The input devices 830 can include a Natural User Interface (NUI).

Wireless modem(s) 860 can be coupled to antenna/antennae (not shown) and can support two-way communications between the processor 810 and external devices, as is well understood in the art. The modem(s) 860 are shown generically and can include a cellular modem 866 for communicating with the mobile communication network 804 and/or other radio-based modems (e.g., Bluetooth 864 and/or Wi-Fi 862). At least one of the wireless modem(s) 860 is typically configured for communication with one or more cellular networks, such as a GSM network for data and voice communications within a single cellular network, between cellular networks, or between the mobile device and a public switched telephone network (PSTN).

Mobile device 802 can further include at least one input/output port 880, a power supply 882, a satellite navigation system receiver 884, such as a Global Positioning System (GPS) receiver, an accelerometer 886, and/or a physical connector 890, which can be a USB port, IEEE 1394 (FireWire) port, and/or RS-232 port. The illustrated components of mobile device 802 are not required or all-inclusive, as any components can be deleted and other components can be added as would be recognized by one skilled in the art.

In one or more embodiments, certain components of mobile device 802 are configured to perform the operations attributed to digital personal assistant 130 as described in preceding sections. Computer program logic for performing the operations attributed to digital personal assistant 130 as described above may be stored in memory 820 and executed by processor 810. By executing such computer program logic, processor 810 may be caused to implement any of the features of digital personal assistant 130 as described above in reference to FIG. 1. Also, by executing such computer program logic, processor 810 may be caused to perform any or all of the steps of any or all of the flowcharts depicted in FIGS. 3-6.

As a client computing device, the mobile device 802 can send requests to a server computing device and receive data in return from the server computing device.

The mobile device 802 can be part of an implementation environment in which various types of services (e.g., computing services) are provided by a computing “cloud.” Some tasks (e.g., processing user input and presenting a user interface) can be performed on local computing devices (e.g., connected devices) while other tasks (e.g., storage of data to be used in subsequent processing, weighting of data and ranking of data) can be performed in the cloud.

Although FIG. 8 illustrates a mobile device 802, more generally, the innovations described herein can be implemented with devices having other screen capabilities and device form factors, such as a desktop computer, a television screen, or device connected to a television (e.g., a set-top box or gaming console). Services can be provided by the cloud through service providers or through other providers of online services. Additionally, since the technologies described herein may relate to audio streaming, a device screen may not be required or used (a display may be used in instances when audio/video content is being streamed to a multimedia endpoint device with video playback capabilities).

### VIII. Illustrative Example of Computer System

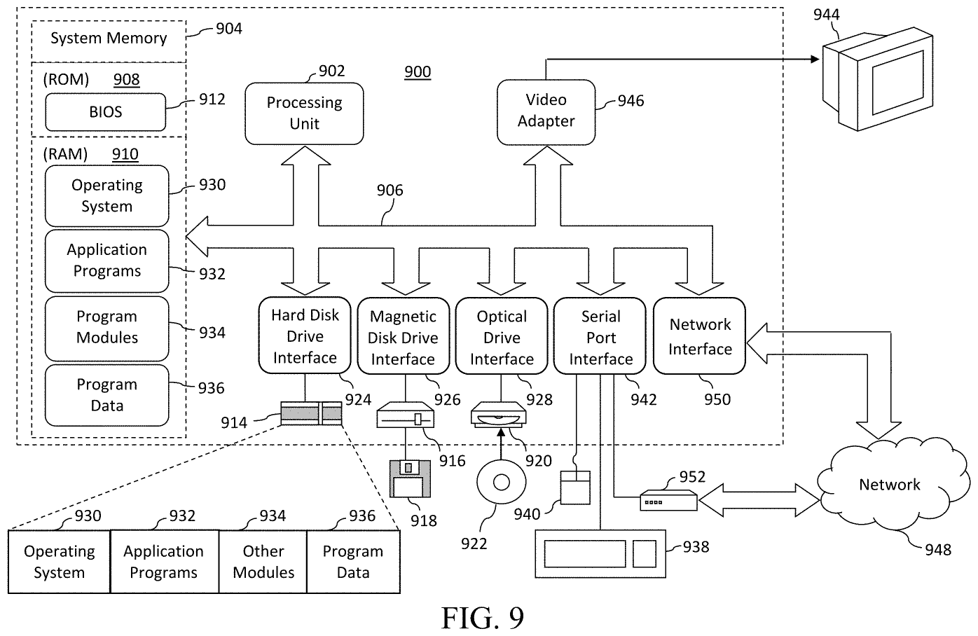

FIG. 9 depicts an example of a processor-based computer system 900 that may be used to implement end user device 102a or any of the computers used to implement digital personal assistant backend 106 as described above in reference to FIG. 1. The description of system 900 provided herein is provided for purposes of illustration, and is not intended to be limiting. One or more embodiments of the present invention may be implemented in other types of computer systems or in computer systems of other configurations.

As shown in FIG. 9, system 900 includes a processing unit 902, a system memory 904, and a bus 906 that couples various system components including system memory 904 to processing unit 902. Processing unit 902 may comprise one or more microprocessors or microprocessor cores. Bus 906 represents one or more of any of several types of bus structures, including a memory bus or memory controller, a peripheral bus, an accelerated graphics port, and a processor or local bus using any of a variety of bus architectures. System memory 904 includes read only memory (ROM) 908 and random access memory (RAM) 910. A basic input/output system 912 (BIOS) is stored in ROM 908.

System 900 also has one or more of the following drives: a hard disk drive 914 for reading from and writing to a hard disk, a magnetic disk drive 916 for reading from or writing to a removable magnetic disk 918, and an optical disk drive 920 for reading from or writing to a removable optical disk 922 such as a CD ROM, DVD ROM, BLU-RAY™ disk or other optical media. Hard disk drive 914, magnetic disk drive 916, and optical disk drive 920 are connected to bus 906 by a hard disk drive interface 924, a magnetic disk drive interface 926, and an optical drive interface 928, respectively. The drives and their associated computer-readable media provide nonvolatile storage of computer-readable instructions, data structures, program modules and other data for the computer. Although a hard disk, a removable magnetic disk and a removable optical disk are described, other types of computer-readable memory devices and storage structures can be used to store data, such as flash memory cards, digital video disks, random access memories (RAMs), read only memories (ROM), and the like.

A number of program modules may be stored on the hard disk, magnetic disk, optical disk, ROM, or RAM. These program modules include an operating system 930, one or more application programs 932, other program modules 934, and program data 936. In accordance with various embodiments, the program modules may include computer program logic that is executable by processing unit 902 to perform any or all of the functions and features of end user device 102 or any of the computers used to implement digital personal assistant backend 106 as described above in reference to FIG. 1. The program modules may also include computer program logic that, when executed by processing unit 902, performs any of the steps or operations shown or described in reference to the flowcharts of FIGS. 3-6.

A user may enter commands and information into system 900 through input devices such as a keyboard and a pointing device/mouse. Other input devices (not shown) may include a microphone, joystick, game controller, scanner, or the like. In one or more embodiments, a touch screen is provided in conjunction with a display 944 to allow a user to provide user input via the application of a touch (as by a finger or stylus for example) to one or more points on the touch screen. These and other input devices are often connected to processing unit 902 through a serial port interface 942 that is coupled to bus 906, but may be connected by other interfaces, such as a parallel port, game port, or a universal serial bus (USB). Such interfaces may be wired or wireless interfaces.

A display 944 is also connected to bus 906 via an interface, such as a video adapter 946. In addition to display 944, system 900 may include other peripheral output devices (not shown) such as speakers and printers.

System 900 is connected to a network 948 (e.g., a local area network or wide area network such as the Internet) through a network interface or adapter 950, a modem 952, or other suitable means for establishing communications over the network. Modem 952, which may be internal or external, is connected to bus 906 via serial port interface 942.

The hard disk associated with hard disk drive 914, the removable magnetic disk 918, the removable optical disk 922, are examples of storage media.

As noted above, computer programs and modules (including application programs 932 and other program modules 934) may be stored on storage media. Such computer programs may also be received via network interface 950, serial port interface 942, or any other interface type. Such computer programs, when executed or loaded by an application, enable computer 900 to implement features of embodiments of the present invention discussed herein. Accordingly, such computer programs represent controllers of the system 900.

In alternative implementations, system 900 may be implemented as hardware logic/electrical circuitry or firmware. In accordance with further embodiments, one or more of these components may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### IX. Privacy

In implementations/aspects/features where user-related data is utilized or shared, it is both contemplated and possible that a variety of mechanisms may be employed in the interests of user privacy and information protection. Such mechanisms can include, without limitation: requiring authorization to monitor, collect, or report data; enabling users to opt in and opt out of data monitoring, collecting, and reporting; employing privacy rules to prevent certain data from being monitored, collected, or reported; providing functionality for anonymizing, truncating, or obfuscating sensitive data which is permitted to be monitored, collected, or reported; employing data retention policies for protecting and purging data; and/or other suitable mechanisms for protecting user privacy.

Additionally, various privacy options may be offered to a user to enable “limited” use and sharing of data, as well as use and sharing of anonymized versions of collected data. Here, it is to be appreciated that user and data privacy is a paramount consideration at all times.

So, for example, it is to be appreciated that it is both contemplated and possible that the collection, use, and/or sharing of task and historical data may be accomplished in a manner that protects security and privacy, including those of the user.

### X. Closing

It is to be appreciated that one or more embodiments of the present invention may include computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable media include, but are not limited to, memory devices and storage structures such as RAM, hard drives, floppy disks, CD ROMs, DVD ROMs, zip disks, tapes, magnetic storage devices, optical storage devices, MEMs, nanotechnology-based storage devices, and the like.

It is to be appreciated that the functionality of one or more of the various components described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Additionally, consistent with one or more contemplated embodiments of the present invention, the digital personal assistant may use any of a variety of artificial intelligence techniques to improve its performance over time through continued interactions with the user. Accordingly, it is reiterated that the disclosed invention is not limited to any particular computer or type of hardware.

It is also to be appreciated that each component of logic (which also may be called a “module” or “engine” the like) of a system such as the system 200 described in FIG. 2 above, and which operates on a computing device, can be implemented using the one or more processing units of one or more computers and one or more computer programs processed by the one or more processing units. A computer program includes computer-executable instructions and/or computer-interpreted instructions, such as program modules, which instructions are processed by one or more processing units in the one or more computers. Generally, such instructions define routines, programs, objects, components, data structures, and so on, that, when processed by a processing unit, instruct the processing unit to perform operations on data or configure the processor or computer to implement various components or data structures. Such components have inputs and outputs by accessing data in storage or memory and storing data in storage or memory.

Further, the inventor reiterates and it is to be appreciated that systems consistent with contemplated embodiments of the present invention, such as system 100 of FIGS. 1A and 1B, may be practiced in distributed computing environments where operations are performed by multiple computers that are linked through a communications network. In a distributed computing environment, computer programs may be located in local and/or remote storage media.

Still further, it is to be understood that instances of the terms “article of manufacture,” “process,” “machine,” and/or “composition of matter” in any preambles of the appended claims are intended to limit the claims to subject matter deemed to fall within the scope of patentable subject matter defined by the use of these terms in 35 U.S.C. § 101.

As the foregoing illustrates, one or more embodiments described herein advantageously implement a “smart” calendaring strategy that relieves users of the burden of having to estimate/predict durations of tasks to be added to a calendar. This strategy automatically estimates the amount of time that a task will take to complete given the information presented by the user, and other data mined from population data (i.e., histories and other sources), allowing a system such as a digital assistant or a calendaring application to make recommendations (e.g. by ranking duration options) or even just block time on the user's behalf. These can save users time in deciding and selecting the appropriate time for an appointment or meeting. Since the system has access to historic data from the user and others, it may even be able to make more accurate predictions than the user themselves.

As the foregoing also illustrates, one or more embodiments described herein advantageously implement a strategy to predict task durations that is applicable to a variety of calendaring implementations, including meeting scheduling involving more than one person by considering the meeting subject, past meetings for all attendees, past meetings involving multiple attendees, relationships between attendees, the agenda, the nature of the meeting (online vs in-person), and so on.

Still further, as the foregoing also illustrates, one or more embodiments described herein advantageously implement a strategy that use a trainable computational model and/or machine learning to automatically predict task duration estimates. This strategy avoids, for example, the cognitive biases all users have when estimating task durations.

Furthermore, as the foregoing also illustrates, one or more embodiments of the present invention can advantageously increase the level of engagement between a user and a digital personal assistant and also promote trust/confidence between the user and the assistant, thereby facilitating continued and/or increased use of and interaction with the digital personal assistant.

Although selected embodiments of the present invention have been shown and described individually, it is to be understood that at least aspects of the described embodiments may be combined. Also, it is to be understood the present invention is not limited to the described embodiment(s). Instead, it is to be appreciated that changes may be made to the one or more disclosed embodiments without departing from the principles and spirit of the invention, the scope of which is defined by the claims and the equivalents thereof. It should be understood that the subject matter defined in the appended claims is not necessarily limited to the specific implementations described above. The specific implementations described above are disclosed as examples only.

What is claimed is:

1. A method, comprising:
identifying one or more characteristics of a task;
resolving one or more predictions of a duration of the task, based on at least one identified characteristic and historical data;
presenting at least one of the one or more resolved predictions; and
receiving feedback concerning an accuracy of the presented at least one of the one or more predictions.

2. The method of claim 1, wherein, in the identifying one or more characteristics of a task, at least one of the one or more characteristics is extracted from input text, from received sound, or from a data file.

3. The method of claim 1, further comprising identifying one or more items of metadata of the task, wherein the resolving is based on at least one item of metadata, and wherein the at least one of the items of metadata is extracted from input text, from received sound, or from a data file.

4. The method of claim 3, wherein the metadata includes one or more of: a time of day at which the task is to be started; a time of day at which the task is to be completed; a participant in the task, a location at which the task is to take place, and a nature of the task.

5. The method of claim 1, further comprising adding the feedback to the historical data, wherein the historical data includes information about:
prior duration estimates for the task involving a user;
prior duration estimates for the task involving users other than a user;
prior duration estimates for tasks similar to the task involving the user;
prior duration estimates for tasks similar to the task involving users other than the user;
prior duration estimates for tasks dissimilar to the task involving the user;
prior duration estimates for tasks dissimilar to the task involving users other than the user; and
rules-based duration estimates.

6. The method of claim 1, wherein the historical data is selected based on at least one of previous task durations, previously received feedback about accuracies of one or more previous task duration estimates, previous task durations estimated for lookalike users, and predetermined estimates.

7. The method of claim 1, wherein at least one of the one or more predictions of a duration of the task:
is in the form of time-based classifications; and
is used to determine a start time for the task.

8. The method of claim 1, further comprising:
adding an entry to a user calendar, when feedback indicates an accuracy of the at least one of the one or more predictions at least matches a threshold;
modifying an order of a plurality of tasks comprising a list based on the one or more resolved predictions; and
providing, when the task is an appointment, the one or more predictions during appointment creation.

9. The method of claim 1, further comprising adding the feedback to the historical data, and wherein the historical data is sharable.

10. The method of claim 1, wherein the resolving one or more predictions of a duration of the task includes using a neural network.

11. The method of claim 1, further comprising finding one or more blocks of time in a calendar to accommodate one of the predictions.

12. A trainable system, comprising:
a task feature identifier portion that identifies one or more characteristics of a task;
a data store that stores historical data including task duration information concerning prior tasks;
a duration predictor that calculates one or more duration predictions of the task, based on the historical data and the one or more characteristics;
a feedback obtainer that receives feedback concerning an accuracy of the one or more duration predictions; and
an updater that adds the feedback to the historical data.

13. The system of claim 12, further comprising a user device by which the system presents the one or more duration predictions, wherein the user device is one or more of a personal digital assistant, a wearable device, and an appliance.

14. The system of claim 13, wherein the user device is remote from the task feature identifier, the duration predictor, and the feedback obtainer.

15. The system of claim 12, wherein the duration predictor includes machine learning logic and compares a result of predictive model with truth data.

16. The system of claim 11, wherein the feedback obtainer receives feedback from a user at one or more specified times, and wherein the one or more specified times include: when the one or more duration predictions are presented, during a task associated with a prediction, and when a task associated with a prediction is completed.

17. The system of claim 12, further comprising a metadata identifier that identifies metadata of the task, and wherein the duration predictor calculates the one or more duration predictions of the task based on identified metadata.

18. A method, comprising:
deducing context information of a task;
identifying relevant historical data related to the task;
calculating duration estimate based on extracted context information and identified relevant historical data;
obtaining feedback about an accuracy of the duration estimate; and
updating historical data with obtained feedback.

19. The method of claim 18, wherein the context information includes one or more characteristics of the task and one or more items of metadata of the task, and wherein the historical data includes data relating to lookalike users and is available to other devices and applications of other users.

20. The method of claim 18, wherein, in the calculating, a machine-learning duration prediction model is used.
